(19) United States
(12) Patent Application Publication
(10) Pub. No.: US 2005/0170035 A1
(43) Pub. Date: Aug. 4, 2005

(54) Container and container fabrication dies

(76) Inventor: Shou-Te Chen, Taichung Hsien (TW)

Correspondence Address: BACON & THOMAS, PLLC, 625 SLATERS LANE, FOURTH FLOOR, ALEXANDRIA, VA, 22314, US

(21) Appl. No.: 10/768,106

(22) Filed: Feb. 2, 2004

(51) Int. Cl. B29C 49/30

(52) U.S. Cl. 425/525

(57) ABSTRACT

A container and container fabrication die comprised of a cylindrical body having a bottom section and, furthermore, an opening shaped at its upper extent, and a rim along the circumference of the opening. The rim is shaped at the inner lateral end of a cylindrical body, and a holding slot is first formed from the cylindrical body. Then, after curving a circular surface, the rim is brought against the distended edge of the holding slot. The container is shaped with a first and a second set of paired half dies as well as a support column.

### BACKGROUND OF THE INVENTION

1) Field of the Invention

The invention herein relates to molded container manufacturing, specifically a container and container fabrication dies in which the hollow tube-like rim along the opening of the container is shaped at the inner lateral end of its cylindrical body and, furthermore, that provides molding dies for manufacturing the said container.

2) Description of the Related Art

At present, some containers have a distinctive type of rim formed along the opening to provide for manual grasping. For example, large flower pots have a rim folded outward from the circumference along the opening at the upper extent of the container, the said rim facilitating lifting by hand to move the entire flower pot. In the invention “Container Manufacturing Method” (U.S. Pat. No. 6,383,440), a container utilizes main body dies, passive dies, active dies, and support column dies such that the active dies and the support column dies function synchronously during a first throw displacement, following which the active dies impel the passive dies to synchronously perform the second throw displacement to thereby finish a container having a hollow tube-like rim along the opening.

However, although the said invention provides a hollow tube-like container opening rim that is feasible, some containers on the market do not always have an opening rim that is formed along the outer lateral end of the container cylindrical body; as such, how to provide a hollow tube-like container opening rim that is formed along the inner lateral end of the container cylindrical body is discussed by the present invention.

### SUMMARY OF THE INVENTION

The objective of the invention herein is to provide a container and container fabrication dies comprised of a cylindrical body having a bottom section and, furthermore, a opening shaped at its upper extent, and a rim along the circumference of the opening in which the rim is shaped at the inner lateral end of a cylindrical body, and a holding slot is first formed from the cylindrical body; then, after curving a circular surface, the rim is brought against the distended edge of the holding slot; and the container is shaped with a first and a second set of paired half dies as well as a support column.

### BRIEF DESCRIPTION OF THE DRAWINGS

Other features and advantages of the present invention will become apparent in the following detailed description of the preferred embodiments, with reference to the accompanying drawings, in which:

FIG. 1 is a cross-sectional drawing of the preferred embodiment container structure of the invention herein.

FIG. 2 is a cross-sectional drawing of the preferred embodiment container rim of the invention herein.

FIG. 3 is a cross-sectional drawing of the preferred embodiment shaping of the invention herein (1).

FIG. 4 is a cross-sectional drawing of the preferred embodiment shaping of the invention herein (2).

FIG. 5 is a cross-sectional drawing of the preferred embodiment shaping of the invention herein (3).

FIG. 6 is a cross-sectional drawing of the preferred embodiment shaping of the invention herein (4).

FIG. 7 is a cross-sectional drawing of the preferred embodiment shaping of the invention herein (5).

FIG. 8 is a cross-sectional drawing of the preferred embodiment shaping of the invention herein (6).

### DETAILED DESCRIPTION OF THE PREFERRED EMBODIMENTS

In the detailed description of the preferred embodiments, it should be noted that identical elements are indicated by the same reference numerals throughout the disclosure.

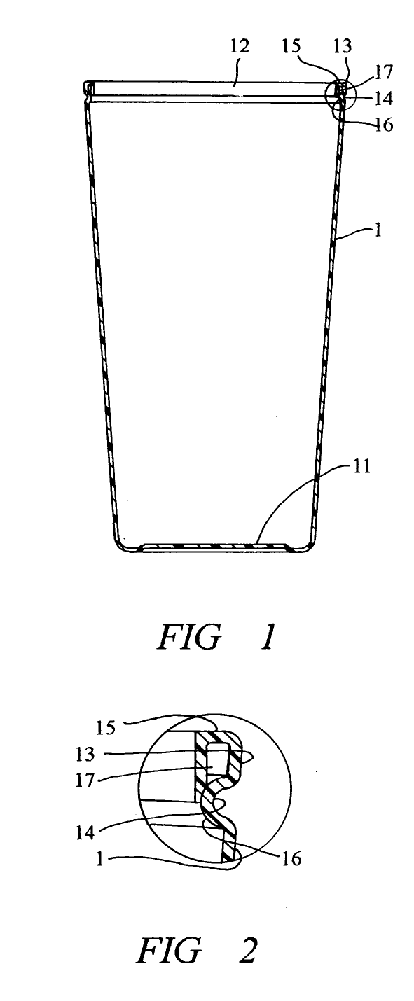

Referring to FIG. 1 and FIG. 2, the preferred embodiment container structure of the invention herein is comprised of a cylindrical body 1 having a bottom section 11, an opening 12 at its upper extent, and an annular rim 13 along the circumference of the said opening 12; the said annular rim 13 is shaped at the inner lateral end of the container cylindrical body 1, an arcuate concave holding slot 14 is first formed towards the center of the opening 12 from the shaped extended portion of the container cylindrical body 1, then extended upwards towards the center of the opening 12 and curved to form a nominally flat circular surface 15, and then downward against an arcuate convex distended edge 16 of the said holding slot 14 inside the cylindrical body 1 and glued thereon such that the rim 13 is formed as a sealed, annularly disposed hollow tube-like spatiality 17.

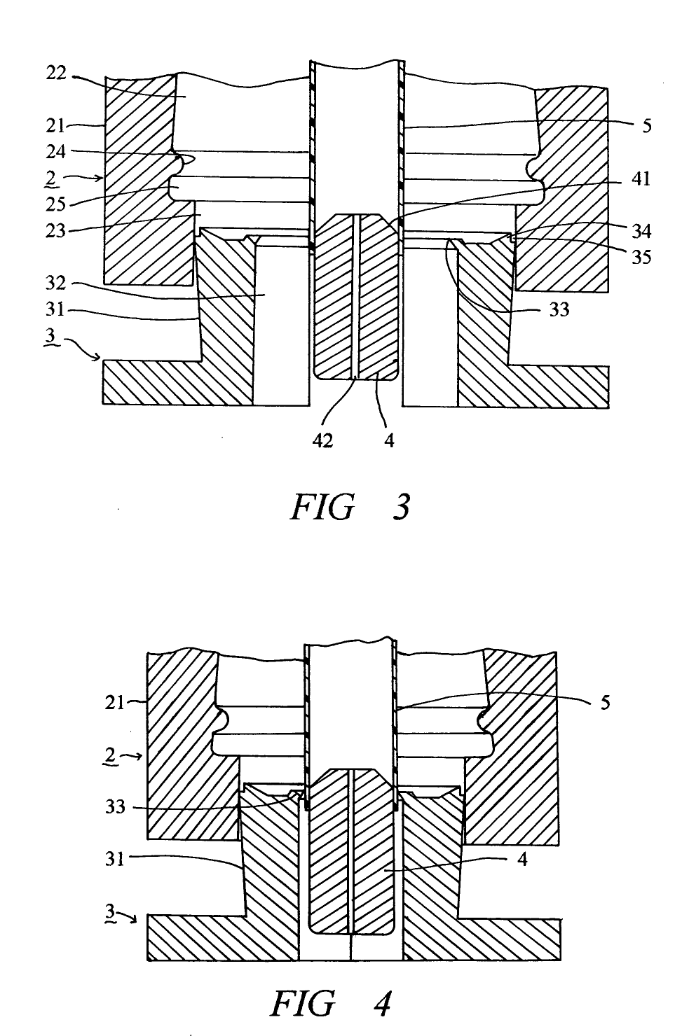

The preferred embodiment container of the invention herein utilizes the dies shown in FIG. 3 to complete molding, which includes:

A first die 2 consisting of two symmetrical half dies 21 that provide for shaping the container body 1; when the two half dies 21 are closed, a hollow cavity 22 is formed in the interior section, a distended edge 24 for shaping the said container holding slot 14 protrudes inward from the inner lateral edges of the die opening 23 near the lower extent of the two half dies 21 and, furthermore, a recess 25 for shaping the said container hollow tube-like spatiality 17 is disposed along the lower extent of the distended edge 24.

A second die 3 consisting of two symmetrical half dies 31 that are movably situated in the die opening 23 of the said first die 2; when the two half dies 31 are closed, an accommodating space 32 is formed in the interior section, a buttressing edge 33 is disposed symmetrically along the inner sides at the upper ends of the two dies 31, an upward facing pointed insertion member 34 is postured at the upper end near the outer side, and a gap 35 is present between the insertion member 34 and the said die opening 23.

A support column 4 positioned in the second die 3 accommodating space 32 that has a guide section 41 at its upper extent and an air flow passage 42 along its interior section.

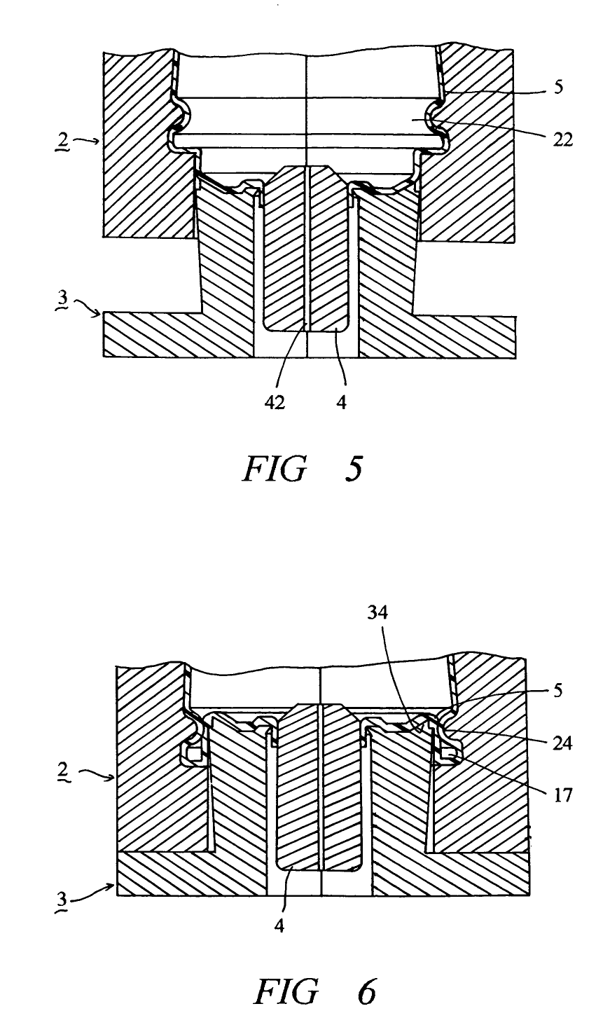

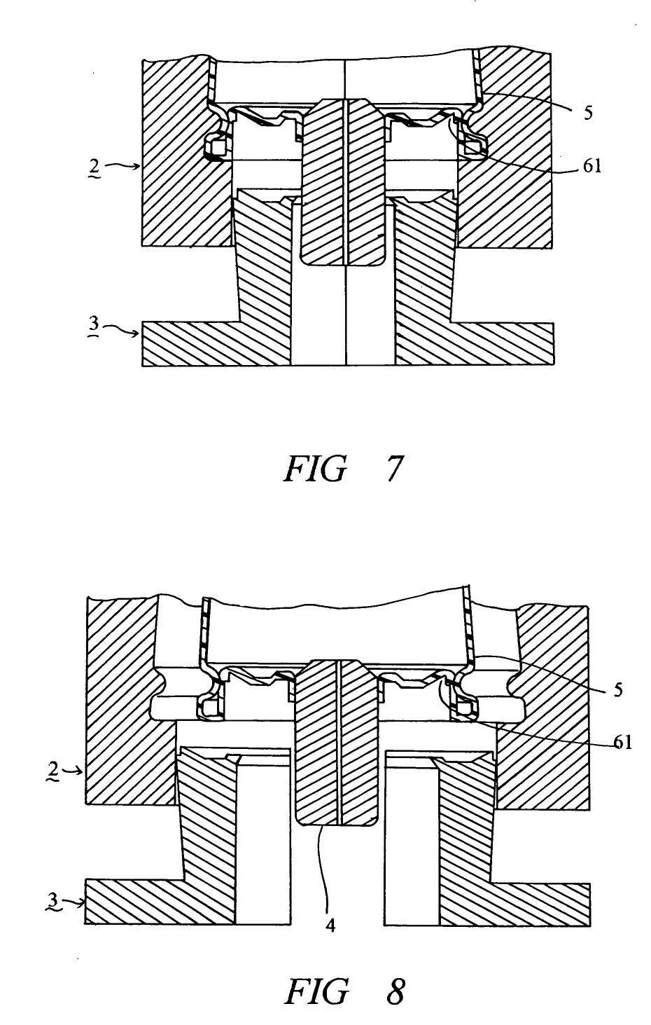

Referring to FIG. 3, when the preferred embodiment dies of the invention herein are formed, an appropriate molten state, half die-shaped, flexile material is flowed into a ductal blank 5 and, when the support column 4 is reached, directed by the conical guide section 41 and supported on the support column 4; following which, as indicated in FIG. 4, the first and second die 2 and 3 half dies 21 and 31 are driven closed, causing the buttressing edge 33 at the upper end of the second die 3 half dies 31 to fit against the outer periphery of the blank 5 on the support column 4 such that the area is in a sealed state; then, as indicated in FIG. 5, air is blown at high pressure from the support column 4 air passage 42 into the ductal blank 5, causing the expansion of the blank 5 against the cavity 22 of the first die 2 and the common surrounding cavity wall surface at the upper end of the second die 3; then, as indicated in FIG. 6, the air is discharged, causing the second die 2 and the support column 4 to move to a forward position such that the blank 5 at the upper end section of the second die 3 insertion member 34 is shifted against the distended edge 24 area of the first die 2 with the said blank 5 in a malleable solid state, at which time the blank 2 is shaped by the sealed hollow tube-like spatiality 17; following which, as indicated in FIG. 7, the second die 3 moves downward to separate the blank 5 and relative to the blank 5, the pointed insertion member 34 of the said second die 3 and the formed pointed narrow groove 61 at said fused solid plastic position are closer to the center line area of the container due to the gap 35; then as indicated in FIG. 8, the first and the second dies 2 and 3 are separated towards two sides such that the blank 5 is only situated on the support column 4, following which a blade is articulated manually along the narrow groove 61 to remove the excess material by trimming annularly and thereby finish the container and, furthermore, since the said narrow groove 61 is more towards the container center line, the cylindrical body 1 is not damaged when trimmed.

The preferred embodiments of the invention herein have the following advantages:

1. The container can be shaped with the hollow tube-like opening rim facing the inner side of the cylindrical body, enabling the container structure design to be even more diverse.

2. The dies of the present invention eliminates the conventional passive dies which not only simplifies die structure, but saves die tooling costs, while also increasing shaping speed to raise productivity and reduce container shaping unit costs.

While the present invention has been described in relation to what is considered the most practical and preferred embodiments, it is understood that the invention herein is not limited to the disclosed embodiments but is intended to cover various arrangements included within the spirit and scope of the broadest interpretations and equivalent arrangements.

1. A container and container fabrication dies comprised of a cylindrical body having a bottom section, an opening at its upper extent, and an annular rim 13 along the circumference of the said opening.
The features of which are: The said annular rim is shaped at the inner lateral end of the said container cylindrical body, and from the shaped portion of the said container cylindrical body, extended and first formed towards the center of the said opening, then after being extended upwards towards the center of the said opening, curved to form a fcircular surface, and then downward against a distended edge of the said holding slot inside the said cylindrical body.

2. As mentioned in claim 1 of the container and container fabrication dies invention herein, the said circular surface of the said rim is curved downward against the said distended edge of the said holding slot inside the said cylindrical body and glued thereon such that the said rim is formed as a sealed, annularly disposed hollow tube-like spatiality.

3. As mentioned in claim 1 of the container and container fabrication dies invention herein, the said circular surface is nominally flat.

4. Molding dies which include:
A first die consisting of two symmetrical half dies; when the said two half dies are closed, a hollow cavity is formed in the interior section, a distended edge protrudes inward from the inner lateral edges of a die opening near the lower extent of the said two half dies and, furthermore, a recess is disposed along the lower extent of the said distended edge.
A second die consisting of two symmetrical half dies that are movably situated in the said die opening of the said first die; when the said two half dies are closed, an accommodating space is formed in the interior section, a buttressing edge is disposed symmetrically along the inner sides at the upper ends, and an upward facing pointed insertion member is postured at the upper end near the outer side.
A support column positioned in the said second die accommodating space that has a guide section at its upper extent and an air flow passage along its interior section.
The said structure is capable of shaping a container having a rim situated at the inner sides of the said cylindrical body.

5. As mentioned in claim 1 of the container and container fabrication dies invention herein, the said second die has a gap present between the said insertion member and the said die opening of the said first die.
